(19) United States
(12) Patent Application Publication
(10) Pub. No.: US 2008/0136251 A1
(43) Pub. Date: Jun. 12, 2008

(54) HYDRAULIC BRAKE SYSTEM FOR VEHICLE AND CONTROL METHOD THEREOF

(76) Inventor: Chan Kyu LEE, Yongin-si (KR)

Correspondence Address: MORGAN, LEWIS & BOCKIUS LLP (SF), One Market, Spear Street Tower, Suite 2800, San Francisco, CA, 94105, US

(21) Appl. No.: 11/829,735

(22) Filed: Jul. 27, 2007

(30) Foreign Application Priority Data
Dec. 12, 2006 (KR) 10-2006-0126003

(51) Int. Cl. B60T 8/34; B60T 8/00; B60T 8/42

(52) U.S. Cl. 303/113.2; 303/115.4

(57) ABSTRACT

A master cylinder supplies pressure to calipers through first to twelfth valves. A hydraulic brake system includes a third accumulator and a thirteenth valve connected to the first and second valves, and a fourth accumulator and a fourteenth valve connected to the seventh and eighth valves. Pressures stored in the third and fourth accumulators are discharged by opening the thirteenth and fourteenth valves when entering a prefill mode. Pressure in a hydraulic line is stored in the third and fourth accumulators by opening the thirteenth and fourteenth valves, closed when entering a reserve mode. A control method includes generating a prefill flag; discharging pressures stored in the third and fourth accumulators by opening the thirteenth and fourteenth valves; allowing the pressures to act on the calipers by closing the thirteenth and fourteenth valves, after discharging fluxes stored in the third and fourth accumulators; and entering a pressure increase control mode.

### CROSS-REFERENCE TO RELATED APPLICATION

This application claims the benefit under 35 U.S.C. §119(a) of Korean Patent Application No. 10-2006-0126003, filed on Dec. 12, 2006, the entire contents of which are incorporated herein by reference.

### BACKGROUND OF THE INVENTION

1. Field of the Invention

The present invention relates to a hydraulic brake system for a vehicle and a control method thereof.

2. Description of Related Art

In general, an inter-vehicle distance control system and a collision mitigation brake system use an electronic stability control (ESC) as a brake actuator. Both systems input brake control parameters, such as brake pressure, brake torque, desired deceleration, etc, to the ESC, which controls the brake based on the control parameters.

There are some inevitable delays in controlling the brake, such as time to initially drive a pump by a motor, time for a brake pad to come into contact with a brake disc, time to generate pressure necessary for the brake pad to overcome a clamping force of a caliper, and time to generate pressure by friction of a hydraulic line. Delay times are about 300 to 1000 ms. Since the delays affect the control performance of the inter-vehicle distance control apparatus, and the collision mitigation brake apparatus requires a pressure generation within several milliseconds, it is necessary to remove such delay times.

Conventional systems utilize a prefill, or prebrake, function, to overcome such delay times. A typical prefill process operates the motor frequently, shortening the lifetime of the motor, and causing unnecessary power consumption.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A vehicle includes a master cylinder that supplies brake pressure to front left (FL) and rear right (RR) calipers through first to sixth valves, and to front right (FR) and rear left (RL) calipers through seventh to twelfth valves. The vehicle also includes first and second accumulators. A hydraulic brake system includes a third accumulator connected to the first and second valves, a thirteenth valve connected to the first and second valves, a fourth accumulator connected to the seventh and eighth valves, and a fourteenth valve connected to the seventh and eighth valves. Pressures stored in the third and fourth accumulators are discharged by opening the thirteenth and fourteenth valves when entering a prefill mode so as to act on the calipers, and a brake pressure in a hydraulic line is stored in the third and fourth accumulators by opening the thirteenth and fourteenth valves closed when entering a reserve mode.

The system may also include a first pump between the first valve and the thirteenth valve, and a second pump between the seventh valve and the fourteenth valve, to compensate for the pressures in the third and fourth accumulators, if not entering a reserve mode as a brake actuator does not perform a pressure increase control mode, although the pressures are discharged in the prefill mode.

The prefill mode may be performed when an acceleration below a reference acceleration is received. The prefill mode may be entered when entering a warning mode, warning a driver of an emergency situation in a standby state; a precollision mode, warning the driver of a more urgent emergency situation and performing a braking control; or a collision mode, performing a full braking operation.

The reserve mode may be entered when returning to the standby state. The reserve check mode may be entered when returning to the standby state, after the prefill mode, and the brake pressure may be supplied to the hydraulic line by driving the first and second pumps.

A control method of such a hydraulic brake system includes generating a prefill flag in a brake actuator; discharging brake pressures stored in the third and fourth accumulators by opening the thirteenth and fourteenth valves for a predetermined time; allowing the brake pressures to act on the calipers by closing the thirteenth and fourteenth valves, after discharging fluxes stored in the third and fourth accumulators; and entering a pressure increase control mode.

The method may further include allowing the brake pressures to act on the third and fourth accumulators, if a reserve flag is generated in a state where pressure values detected in the calipers are greater than a first reference value; and storing the brake pressures in the third and fourth accumulators by closing the thirteenth and fourteenth valves, if the pressure values are below a second reference value while performing a pressure reduction control.

The method may further include generating a reserve check flag, if the pressure increase control mode is not entered, although the brake pressure is discharged; allowing the brake pressure to act on the third and fourth accumulators through the first and thirteenth valves and through the seventh and fourteenth valves by closing the fourth to sixth and tenth to twelfth valves and driving first and second pumps; and storing the brake pressure by stopping the first and second pumps and closing the first and thirteenth valves and the seventh and fourteenth valves, if a pressure value in a caliper is greater than a reference value.

### BRIEF DESCRIPTION OF THE DRAWINGS

The above and other features of the present invention will be described with reference to certain exemplary embodiments thereof illustrated the attached drawings in which:

FIG. 1 is a schematic diagram depicting a hydraulic brake system for a vehicle in accordance with an exemplary embodiment of the present invention;

FIG. 2 is a diagram illustrating mode selection flags of an inter-vehicle distance control apparatus in accordance with an exemplary embodiment of the present invention; and

FIG. 3 is a diagram illustrating mode selection flags of a collision mitigation brake apparatus in accordance with an exemplary embodiment of the present invention.

Brief description of reference numeral indicating primary elements in the drawings:

| | |
|---|---|
| 10: First Part | 11: Second Part |
| 12: First valve | 18: Seventh valve |
| 13: Second valve | 19: Eighth valve |
| 14: Third valve | 20: Ninth valve |
| 15: Fourth valve | 21: Tenth valve |
| 16: Fifth valve | 22: Eleventh valve |
| 17: Sixth valve | 23: Twelfth valve |
| 24: Thirteenth valve | 25: Fourteenth valve |
| 26: First accumulator | 27: Second accumulator |
| 28: Third accumulator | 29: Fourth accumulator |
| 30: First pump | 31: Second pump |
| 32: First pressure sensor | 34: Third pressure sensor |
| 33: Second pressure sensor | 35: Fourth pressure sensor |
| 37: Front left (FL) caliper | 39: Front right (FR) caliper |
| 38: Rear right (RR) caliper | 40: Rear left (RL) caliper |
| 41: Master cylinder | |

### DETAILED DESCRIPTION OF THE PREFERRED EMBODIMENTS

Hereinafter, preferred embodiments of the present invention will be described with reference to the accompanying drawings. The preferred embodiments are provided so that those skilled in the art can sufficiently understand the present invention, but can be modified in various forms and the scope of the present invention is not limited to the preferred embodiments.

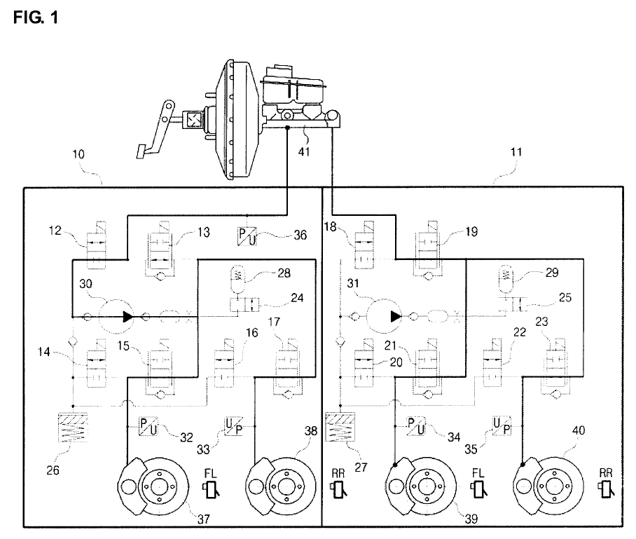

Referring to FIG. 1, a hydraulic brake system includes a first part 10 and a second part 11. The first and second parts 10 and 11 may have the same structure; however, the first part 10 is connected to front left (FL) and rear right (RR) wheels, and the second part 11 is connected to front right (FR) and rear left (RL) wheels.

The flow of hydraulic pressure for each operational mode of the first part 10 will be described as follows. It should be appreciated that the second part 11 may operate in identically the same way, so a description of the second part 11 will be omitted.

1. Driver Braking Mode

Master cylinder 41→second valve 13→fourth valve 15→FL caliper 37

Master cylinder 41→second valve 13→sixth valve 17→RR caliper 38

2. Brake Pressure Increase Control Mode

Master cylinder 41→second valve 13→first pump 30→fourth valve 15→FL caliper 37

Master cylinder 41→second valve 13→first pump 30→sixth valve 17→RR caliper 38

3. Brake Pressure Reduction Control Mode

FL caliper 37→fourth valve 15→second valve 13→master cylinder 41

RR caliper 38→sixth valve 17→second valve 13→master cylinder 41

In these three control modes, the first, third and fifth valves 12, 14 and 16 are closed.

Pressure control modes are as follows.

4. Prefill Mode

Third accumulator 28→thirteenth valve 24→fourth valve 15→FL caliper 37

Third accumulator 28→thirteenth valve 24→sixth valve 17→RR caliper 38

5. Reserve Mode

FL caliper 37→fourth valve 15→thirteenth valve 24→third accumulator 28

RR caliper 38→sixth valve 17→thirteenth valve 24→third accumulator 28

The prefill mode is operated by a prefill flag, and stores pressure in the third accumulator 28. The pressure stored in the third accumulator 28 acts on the FL and RR calipers 37 and 38 by closing the first, second, third and fifth valves 12, 13, 14 and 16 and by opening the thirteenth, fourth and sixth valves 24, 15 and 17.

The pressure stored in the third accumulator 28 can be regulated according to the force of an inner spring or the amount of charged gas. The spring strength or the charged gas amount may be preset so that the maximum charge pressure that acts on the FL and RR calipers 37 and 38 is 3-5 bar when the stored flux is discharged by opening the thirteenth valve 24.

After discharging the stored flux, the thirteenth valve 24 is closed, and a pressure control is performed by entering the pressure increase control mode, so as to reduce the delay time for generating the flux and pressure necessary to decrease a clearance between the brake pad the brake disc.

Accordingly, when the pumps operate, the pressure increases immediately without any initial delay.

The reserve mode is directed to a process of receiving and storing the flux again after the third accumulator 28 discharges the flux.

During the pressure decrease mode, brake pressure has already been formed in the hydraulic line. Accordingly, in the process of returning the brake pressure to the master cylinder 41, after storing predetermined flux and pressure in the third accumulator 28 by opening the thirteenth valve 24, the reserve mode, closing the thirteenth valve 24, is performed, and then the pressure reduction control mode is carried out continuously.

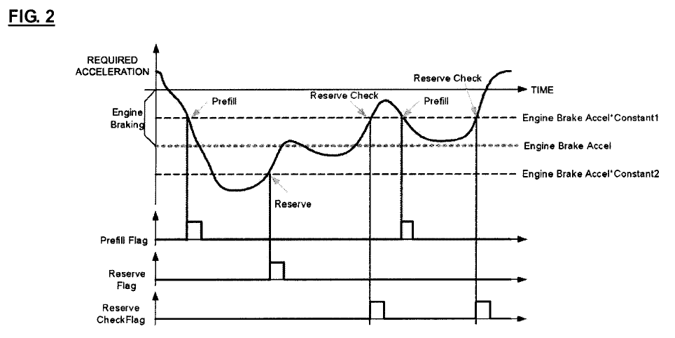

In more detail, referring to FIG. 2, the inter-vehicle distance control apparatus calculates required acceleration and instructs the brake actuator (ESC) to carry out the required acceleration.

The brake actuator calculates a maximum deceleration that an engine can generate as engine braking is provided by a fuel cut operation with torque information of engine. Such a value is referred to as “engine brake accel” in FIG. 2. The prefill flag is performed when an acceleration order below a predetermined reference of the engine brake accel is received (passing through the predetermined reference from positive to negative), and the reserve flag is performed when reducing the deceleration as much as a predetermined multiple of the engine brake accel (passing through the predetermined reference from negative to positive).

Moreover, in preparation for a situation where reserve mode conditions are not provided after the pressure is discharged in the prefill mode, a reserve check flag is calculated. As depicted in FIG. 2, such a reserve check flag is generated when passing through the predetermined reference from negative to positive.

Accordingly, if the prefill flag is generated internally, the ESC opens the thirteenth and fourteenth valves for a predetermined time to discharge the pressures stored in the third and fourth accumulators.

The pressure control process by the reserve flag will be described as follows.

If the prefill flag is generated during the pressure control, i.e., when the pressure values detected by first to fourth pressure sensors 32 to 35 are greater than a reference value, the thirteenth and fourteenth valves 24 and 25 are opened so that the same pressure as the hydraulic line generated at present acts on the third and fourth accumulators 28 and 29.

Here, if the detected values of the first to fourth pressure sensors 32 to 35 are below the reference value, while the pressure decrease mode is performed continuously, the thirteenth and fourteenth valves 24 and 25 are closed to store the pressure and the pressure reduction control is performed continuously.

Moreover, if not entering the reserve mode as the ESC has not performed the pressure increase control mode, although the pressure is discharged by performing the prefill mode, the pressures of the third and fourth accumulators 28 and 29 are empty.

To compensate for this situation, the reserve check flag is generated to store the pressure in the sequential order of the master cylinder 41, the first valve 12, the first pump 30, the thirteenth valve 24, and the third accumulator 28 by driving the first and second pump 30 and 31. If the pressure value detected by the first pressure sensor 32 is greater than the reference value, the operation of the first pump 30 is stopped and the first and thirteenth valves 12 and 24 are closed. At this time, the fourth to sixth valves 15 to 17 are closed.

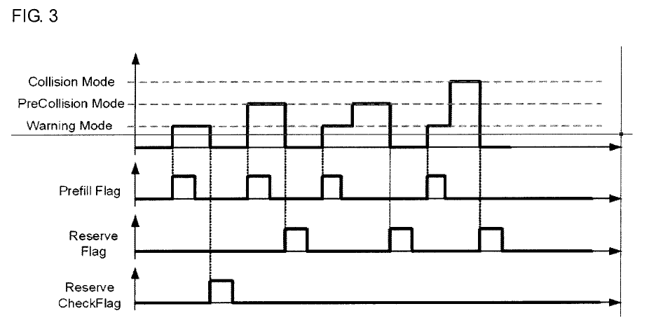

Referring to FIG. 3, the collision mitigation brake apparatus includes a warning mode, warning a driver of an emergency situation in a standby state; a precollision mode, warning the driver of a more urgent emergency situation and performing braking control; and a collision mode, performing full braking operation in a collision situation. These modes are variable in a standby state.

The prefill mode is generated when the standby state enters the warning mode, the precollision mode, or the collision mode.

The reserve flag is generated when returning to the standby state after the pressure control, and thereby the pressure is stored when the precollision mode or the collision mode changes into the standby state.

Meanwhile, since there is not enough pressure that the accumulators 28 and 29 can store in the hydraulic line when returning to the standby state after the accumulators 28 and 29 discharge the pressure by performing the prefill function while entering the warning mode, the pressure should be supplied to the hydraulic line forcibly by generating the reserve check flag to drive the pumps.

The control methods of the prefill mode, reserve mode, and reserve check flag are the same as the pressure control process required by the inter-vehicle distance control apparatus.

Accordingly, embodiments of the present invention perform the prefill mode, reserve mode and reserve check mode by including additional valves and accumulators, thus enhancing control performance by improving the response performance of the inter-vehicle distance control apparatus and providing a more rapid deceleration for collision risk by improving the response performance of the collision mitigation brake apparatus. Furthermore, embodiments of the present invention decrease power consumption and noise by reducing the motor operation for performing the prefill function, and thereby improve the durability of the motor.

In FIG. 1, the first to twelfth valves 12 to 23 may be solenoid valves. The first and second accumulators 26 and 27 may be low pressure accumulators for storing brake fluid supplied to wheel calipers.

While preferred embodiments of the present invention have been described and illustrated, the present invention is not limited thereto. On the contrary, it should be understood that various modifications and variations of the present invention can be made by those skilled in the art without departing from the spirit and the technical scope of the present invention as defined by the appended claims.

What is claimed is:

1. A hydraulic brake system for a vehicle, the vehicle comprising a master cylinder that supplies brake pressure to front left (FL) and rear right (RR) calipers through first to sixth valves, and to front right (FR) and rear left (RL) calipers through seventh to twelfth valves, the vehicle further comprising first and second accumulators, the system comprising:
a third accumulator connected to the first and second valves;
a thirteenth valve connected to the first and second valves;
a fourth accumulator connected to the seventh and eighth valves; and
a fourteenth valve connected to the seventh and eighth valves;
wherein pressures stored in the third and fourth accumulators are discharged by opening the thirteenth and fourteenth valves when entering a prefill mode so as to act on the calipers, and a brake pressure in a hydraulic line is stored in the third and fourth accumulators by opening the thirteenth and fourteenth valves closed when entering a reserve mode.

2. The system of claim 1, further comprising a first pump between the first valve and the thirteenth valve, and a second pump between the seventh valve and the fourteenth valve, to compensate for the pressures in the third and fourth accumulators, if not entering a reserve mode as a brake actuator does not perform a pressure increase control mode, although the pressures are discharged in the prefill mode.

3. The system of claim 1, wherein the prefill mode is performed when an acceleration below a reference acceleration is received.

4. The system of claim 2, wherein the prefill mode is entered when entering a warning mode, warning a driver of an emergency situation in a standby state; a precollision mode, warning the driver of a more urgent emergency situation and performing a braking control; or a collision mode, performing a full braking operation.

5. The system of claim 4, wherein the reserve mode is entered when returning to the standby state.

6. The system of claim 4, wherein the reserve check mode is entered when returning to the standby state, after the prefill mode, and the brake pressure is supplied to the hydraulic line by driving the first and second pumps.

7. A control method of a hydraulic brake system for a vehicle, the vehicle comprising a master cylinder that supplies brake pressure to front left (FL) and rear right (RR) calipers through first to sixth valves, and to front right (FR) and rear left (RL) calipers through seventh to twelfth valves, the vehicle further comprising first and second accumulators, the system comprising a third accumulator connected to the first and second valves, a thirteenth valve connected to the first and second valves, a fourth accumulator connected to the seventh and eighth valves, and a fourteenth valve connected to the seventh and eighth valves, the method comprising:
generating a prefill flag in a brake actuator;
discharging brake pressures stored in the third and fourth accumulators by opening the thirteenth and fourteenth valves for a predetermined time;
allowing the brake pressures to act on the calipers by closing the thirteenth and fourteenth valves, after discharging fluxes stored in the third and fourth accumulators; and
entering a pressure increase control mode.

8. The method of claim 7, further comprising:
allowing the brake pressures to act on the third and fourth accumulators, if a reserve flag is generated in a state where pressure values detected in the calipers are greater than a first reference value; and
storing the brake pressures in the third and fourth accumulators by closing the thirteenth and fourteenth valves, if the pressure values are below a second reference value while performing a pressure reduction control.

9. The method of claim 7, further comprising:
generating a reserve check flag, if the pressure increase control mode is not entered, although the brake pressure is discharged;
allowing the brake pressure to act on the third and fourth accumulators through the first and thirteenth valves and through the seventh and fourteenth valves by closing the fourth to sixth and tenth to twelfth valves and driving first and second pumps; and
storing the brake pressure by stopping the first and second pumps and closing the first and thirteenth valves and the seventh and fourteenth valves, if a pressure value in a caliper is greater than a reference value.
